(19) United States
(12) Patent Application Publication
(10) Pub. No.: US 2007/0109780 A1
(43) Pub. Date: May 17, 2007

(54) Ornament light chain circuit

(76) Inventors: Wing Ho Raymond Lee, Tsimshatsui (HK); Chu Kwok Woo, Tsimshatsui (HK)

Correspondence Address: RABIN & BERDO, P.C.;Suite 500, 1101 14 Street, N.W., Washington, DC, 20005, US

(21) Appl. No.: 11/474,449

(22) Filed: Jun. 26, 2006

(30) Foreign Application Priority Data
Nov. 16, 2005 (CN) 200520129091.5

(51) Int. Cl. F21S 13/14

(52) U.S. Cl. 362/252

(57) ABSTRACT

An ornament light chain circuit comprising a plurality of LEDs, a switch circuit, a pressure sensor, a signal amplification circuit connecting to the said pressure sensor, a chip including a switch terminal, a light signal terminal and a signal input terminal with the said switch terminal connecting to the switch circuit, the said light signal terminal connecting to the said LEDs, and the signal input terminal connecting to the signal amplification circuit so as when its user blows air to the pressure sensor, the sensor detects a pressure signal, the pressure signal is amplified by the signal amplification circuit and then transmitted to the signal input terminal, and then the chip turns off the LEDs via the light signal terminal. The present light chain can be served as an electronic candle. Such an ornament light chain circuit can be applied in greeting cards, birthday cakes, dolls and the like.

### FIELD OF THE INVENTION

The present invention relates to an ornament light chain circuit, particularly a circuit that can have the lights turned off by blowing air to it.

### BACKGROUND OF THE INVENTION

Normally on and off of ornament light chain are controlled manually by pressing a switch. In many occasions, ornament light chains are used on toys, during birthday or other festivals. For instance, ornament light chains are used on seasonal greeting cards, birthday cakes, dolls, stuffed toys, and the light. They are also used in combination with music for celebration purpose. In some particular occasions, there have to some particular types of entertainment effects. Particularly while using on birthday cake, the ornament light is used instead of birthday candle. If extinguishing of the ornament light is controlled by pressing of switch, the fun and entertainment effect is apparently lowered.

### SUMMARY OF THE INVENTION

The objective of the present invention is to provide an ornament light chain circuit to solve the existing technical issue—the need of manual control to turn off the ornament light chain.

To achieve the aforesaid objective, the following solution is disclosed in the present invention:

An ornament light chain circuit comprising a plurality of lights LEDs, a switch circuit, a pressure sensor, a signal amplification circuit connecting to the said pressure sensor, a chip including a switch terminal, a light signal terminal and a signal input terminal with the switch terminal connected to the switch circuit, the light signal terminal connected to the said lights LEDs and the signal input terminal connected to the said signal amplification circuit.

With the ornament light chain circuit having a structure described above, when the user blows air toward the pressure sensor, the pressure sensor receives a pressure signal, the pressure signal is amplified by the signal amplification circuit and then transmitted to the signal input terminal. Consequently, the chip darkens, or turns off the LEDs via the light signal terminal. In this way, the ornament light chain is served as an electronic candle, the user can imitate the process of candle extinguishing with such a design. It is easy to use and it provides a good effect. Such an ornament light chain circuit can be applied in seasonal greeting card, birthday cakes, dolls, stuffed toys, and the like.

The said chip is integrated with a timer module.

The said chip includes a control signal output terminal; the signal amplification circuit is connected to a speaker. When the switch terminal is activated, the control signal output terminal gives an audio frequency to playback music via the speaker.

A triode is connected between the said control signal output terminal and the signal amplification circuit.

The said chip includes a power supply terminal connecting to the said signal amplification circuit and supplies power to the pressure sensor. When music is played, the power supply terminal discontinues power supply to the pressure sensor. In other words, blowing air to the pressure sensor while the music is played will not extinguish the lights.

The speaker can be integrated with the pressure sensor to simplify the circuit structure.

The said chip includes an oscillation input terminal connecting to the power source via a resistor to generate a switching frequency for activating the chip.

### BRIEF DESCRIPTION OF THE DRAWING

FIG. 1 is a circuit diagram for the ornament light chain circuit according to the present invention.

### DETAILED DESCRIPTION OF THE PREFERRED EMBODIMENT

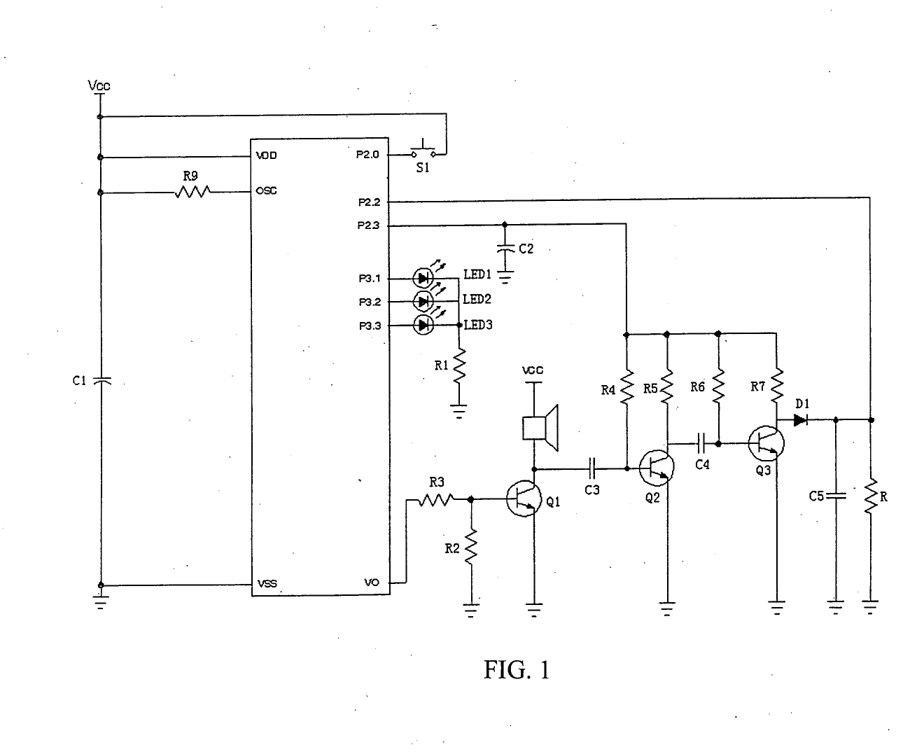

A preferred embodiment of the present invention is described below with reference to FIG. 1 to provide a better understanding on the functions and features of the present invention.

The ornament light chain circuit according to the present invention comprises a chip 2 with built-in timer module, and a pressure sensor circuit X. A plurality of lights LED1, LED2 and LED3 are connected to the light signal terminals P3.1, P3.2 and P3.3 on the chip. The lights LED1, LED2 and LED3 are connected in parallel and then earthed via a resistor R1. A signal input terminal P2.2 is connected to a signal amplifier circuit B and another signal amplified circuit A in sequence.

An end of a speaker 1 is connected to a power source VCC, while its other end is connected to the signal amplifier circuit A and the signal amplifier circuit B in sequence, and connected to the collector of a triode Q1 at the same time. There is a capacitor C3 between the collector of the triode Q1 and the base of another triode Q2. An oscillation input terminal OSC is connected to the power source VCC via a resistor R9, and earthed via a resistor R9 and a capacitor C1. The resistor R9 is used to generate a switching frequency, the oscillation input terminal OSC causes the chip to start operation. A control signal output terminal VO is earthed via resistors R3 and R2, and connected to the base of the triode Q1 via the resistor R3. The emitter of the triode Q1 is earthed. Normally the control signal output terminal VO does not give any signal; it gives audio frequency only when music is played back. A switch S1 is connected between the switching terminal P2.0 and the power source VCC. The positive terminal of the working power source is connected to the power source VCC, its negative terminal VSS is earthed. The power supply terminal P2.3 is earthed via a capacitor C2. Resistors R4, R5, R6 and R7 are connected to the power supply terminal P.2.3 in parallel.

The signal amplifier circuit A is composed of a capacitor C3, two resistors R4 and R5, and a triode Q2. The signal amplifier circuit B is composed of three resistors R6, R7 and R8, two capacitors C4 and C5, a triode Q3 and a rectifier diode D1. The resistor R4 is connected to the base of the triode Q2, while the resistor R5 is connected to the collector of the triode Q2. The collector of the triode Q2 is connected to the base of the triode Q3 via the capacitor C4. The resistor R6 is connected to the base of the triode Q3, while the resistor R7 is connected to the collector of the triode Q3. The emitters of the triodes Q2 and Q3 are earthed respectively. An end of the diode D is connected to the triode Q3, while its other end is earthed after parallel connecting to the capacitor C5 and the resistor R8. The resistor R8 is connected to the signal input terminal P2.2.

After pressing a switch S1, the control signal output terminal VO is activated to give audio frequency, and starts playing back music via a speaker 1. At the same time, the light signal terminals P3.1, P3.2 and P3.3 control the lights LED1, LED2 and LED3 to start flickering. As soon as the timer in the chip completes a timing cycling, for instance, a period of 20 seconds, the music is stopped, the user may blow to the speaker 1, then the speaker 1 receives a vibrating pressure, and transmits the pressure detected to the signal input terminal P2.2 via the signal amplifier circuits A and B. The signal input terminal P2.2 senses the strength of the pressure blown, and accordingly darkens the intensity or turns off the lights LED1, LED2 and LED3. After the music is stopped, the lights LED1, LED2 and LED3 will continue flickering for 20 seconds, then the chip's power supply terminal P2.3 supplies power to the speaker 1 to activate a pressure sensor circuit. When the music is played, the power supply terminal P2.3 discontinues power supply to the speaker 1. If the air is blown to the speaker 1 during playing of the music, the lights LED1, LED2 and LED3 will not be extinguished.

The foregoing description of the preferred embodiment has been presented for purposes of illustration and description. It is not intended to be exhaustive or to limit the invention to the precise form disclosed. Obvious modifications or variations are possible in light of the above teachings. The embodiment described was chosen to provide the best illustration of the principles of the invention and its practical application to thereby enable one of ordinary skill in the art to utilize the inventions in various embodiments and with various modifications as are suited to the particular scope of the invention as determined by the appended claims when interpreted in accordance with the breadth to which they are fairly, legally and equitably entitled. For instance, the speaker in the present invention may be integrated with the pressure sensor as a single unit, or the speaker and the pressure sensor may be installed as two separate units.

1. An ornament light chain circuit comprising a plurality of LEDs and a switch circuit, characterized by the provision of a pressure sensor, a signal amplification circuit connected to the said pressure sensor, a chip including a switch terminal, a light signal terminal and a signal input terminal wherein the switch terminal is connected to the switch circuit, the light signal terminal is connected to the said LEDs and the signal input terminal is connected to the signal amplification circuit; the pressure signal detected by the pressure sensor is amplified by the signal amplification circuit and then transmitted to the signal input terminal so as the chip can darken or turn off the LEDs via the light signal terminal.

2. An ornament light chain circuit as claimed in claim 1 characterized by the integration of a timer module in the said chip.

3. An ornament light chain circuit as claimed in claim 2 wherein the said chip has a control signal output terminal, the signal amplification circuit is connected to a speaker, and the control signal output terminal is controlled after the switch terminal is activated to give audio frequency for playing a music via the speaker.

4. An ornament light chain circuit as claimed in claim 3 characterized by a triode connected between the control signal output terminal and the signal amplification circuit.

5. An ornament light chain circuit as claimed in claim 3 wherein the said chip includes a power supply terminal connecting to the said signal amplification circuit to supply power to the pressure sensor, and the power supply terminal discontinues power supply to the pressure sensor during playing of music.

6. An ornament light chain circuit as claimed in claim 5 herein the pressure sensor is integrated in the said speaker.

7. An ornament light chain circuit as claimed in claim 1 wherein the chip includes an oscillation input terminal to connect to the power source via a resistor to generate a switching frequency to activate the chip.

8. An ornament light chain circuit as claimed in claim 4 wherein the said chip includes a power supply terminal connecting to the said signal amplification circuit to supply power to the pressure sensor, and the power supply terminal discontinues power supply to the pressure sensor during playing of music.

9. An ornament light chain circuit as claimed in claim 8 herein the pressure sensor is integrated in the said speaker.
